(19) United States
(12) Patent Application Publication
(10) Pub. No.: US 2015/0219405 A1
(43) Pub. Date: Aug. 6, 2015

(54) CLADDED BRAZED ALLOY TUBE FOR SYSTEM COMPONENTS

(71) Applicant: Lennox Industries Inc., Richardson, TX (US)

(72) Inventor: Subba Rao Karavadi, Frisco, TX (US)

(73) Assignee: Lennox Industries Inc., Richardson, TX (US)

(21) Appl. No.: 14/173,367

(22) Filed: Feb. 5, 2014

(51) Int. Cl. F28F 1/12; B23P 15/26

(52) U.S. Cl. CPC F28F 1/12; B23P 15/26

(57) ABSTRACT

A heat exchanger includes at least one hairpin tube and at least one fin. The hairpin tube may be made of metal and may be cladded in a braze alloy. A heat exchanger includes at least one hairpin tube formed by rolling and securing a sheet of a metal into a cylindrical shape, and at least one fin. The hairpin tube may be cladded in a braze alloy and the sheet of metal may include enhancements formed by surface treatment. A method for forming a heat exchanger includes cladding hairpin tubes with a braze alloy, positioning fins to engage the braze alloy and forming a metallurgic bond between the fins and hairpin tubes by heat treating.

### TECHNICAL FIELD

The present disclosure relates generally to tube and fin heat exchangers, and more particularly, to braze alloy cladded tubes for tube and fin heat exchangers to allow for high efficient heat transfer and to substantially prevent stress corrosion.

### BACKGROUND

Tube and fin heat exchangers may be used to transfer heat from one medium to another. Tube and fin heat exchangers may be used in applications such as heating, ventilation and air conditioning (HVAC) systems, space heating, refrigeration, industrial settings, and/or other applications.

Tube and fin heat exchangers require the tube to engage the fin to operate. Conventional tube and fin heat exchangers utilize expanders to cause the hairpin tubes to expand radially outwards to engage the fins. Over time, the stress caused to the hairpin tubes from this process leads to corrosion and decrease heat efficiency due to mechanical damage to enhancements formed on the interior surface of the hairpin tubes, necessitating maintenance or replacement. The use of expanders also limits the length and diameter of the hairpin tubes due to the maximum length and minimum diameter of conventional expanders that are required to be disposed through the hairpin tubes in order for the hairpin tubes to engage the fins.

Further, conventional hairpin tubes are made of AA3003 aluminum alloy, which provides high heat transfer efficiency. However, AA3003 aluminum alloy is susceptible to stress corrosion, as described above, and also becomes hard and brittle if heated.

### SUMMARY

Embodiments of the present disclosure generally provide systems and methods of braze alloy cladded tubes for heat exchangers to allow for the use of heat treatable alloys and thereby substantially prevent stress corrosion.

In an embodiment, the present disclosure provides a heat exchanger, for use in a heating, ventilation and air conditioning (HVAC) system, comprising at least one hairpin tube made of a metal and cladded in a braze alloy, and at least one fin. The braze alloy may be sprayed onto a hairpin tube that may be extruded or welded. In an embodiment, the braze alloy may be mechanically coupled to a sheet of metal to form a sheet of material. The hairpin tube may be formed by rolling and securing the sheet of material into a cylindrical shape. In another embodiment, the braze alloy may be mechanically coupled to a hairpin tube after extrusion.

In another embodiment, the present disclosure provides a heat exchanger, for use in a heating, ventilation and air conditioning (HVAC) system, comprising at least one hairpin tube formed by rolling and securing a sheet of a metal into a cylindrical shape, and at least one fin. The hairpin tube may be cladded in a braze alloy and the sheet of metal may include enhancements formed by surface treatment. The braze alloy may be sprayed onto a hairpin tube or mechanically coupled to the hairpin tube. The enhancements may comprise linear trenches, crosshatched trenches, wavy trenches or other suitable pattern.

In an embodiment, the present disclosure provides a method for forming a heat exchanger for use in a heating, ventilation and air conditioning (HVAC) system, comprising installing cladding hairpin tubes with a braze alloy, positioning fins to engage the braze alloy and forming a metallurgic bond between the fins and hairpin tubes by heat treating. The method may further comprise mechanically surface treating an interior surface of the hairpin tubes to form enhancements.

In an embodiment, the metal may be a heat treatable alloy and the braze alloy may have a lower melting temperature than the metal. The braze alloy may be formed of one of the following: zinc, aluminum, silicon.

In an embodiment the hairpin tube may have a diameter less than 0.325 inches.

The details of various embodiments are set forth in the accompanying drawings and the description below. Other features, objects and advantages of the embodiments will be apparent from the description and the drawings.

### BRIEF DESCRIPTION OF THE DRAWINGS

For a more complete understanding of the present disclosure and its features, reference is now made to the following description, taken in conjunction with the accompanying drawings, in which:

FIG. 1 is an exemplary illustration of a portion of a tube and fin heat exchanger system in a disengaged state accordance with one embodiment of the present disclosure;

FIG. 2A is a partially exploded perspective view of a hairpin tube shown in FIG. 1 in accordance with one embodiment of the present disclosure;

FIG. 2B is a perspective view of the hairpin tube shown in FIG. 2A in a pre-formed position in accordance with one embodiment of the present disclosure;

FIG. 3 is an exemplary illustration of the system of FIG. 1 in an engaged state in accordance with one embodiment of the present disclosure;

FIG. 4 is a side view of a hairpin tube shown in FIG. 1 in a pre-formed position in accordance with another embodiment of the present disclosure;

FIGS. 5a-5c are exemplary illustrations of enhancements that may be employed in conjunction with the hairpin tube of FIG. 4 in accordance with one embodiment of the present disclosure;

FIG. 6A is a partially exploded perspective view of the hairpin tube of FIG. 4 in a partially formed position in accordance with one embodiment of the present disclosure;

FIG. 6B is a perspective view of the hairpin tube of FIG. 6A in a pre-formed position in accordance with one embodiment of the present disclosure; and

FIG. 7 is a cross section view of the hairpin tube of FIG. 4 in a formed position in accordance with one embodiment of the present disclosure.

### DETAILED DESCRIPTION

The present disclosure generally provides systems and methods of braze alloy cladded tubes for tube and fin heat exchangers.

Braze alloy cladded tubes for heat exchangers for use in conjunction with heating, ventilation and air condition (HVAC) systems may provide for substantially improved heat transfer efficiency and relieve stress on the hairpin tubes thereby providing improved corrosion resistance.

Cladding may be used in conjunction with conventionally produced hairpin tubes or hairpin tubes produced in any other suitable method or manner. Conventional hairpin tubes are produced via extrusion. The extrusion process involves metal rods being forced through a die with a shaped opening. A billet is pushed through the metal rods to create the hairpin tubes. The billet causes an enhancement having a specific pattern to be imprinted onto the interior surface of the hairpin tube. The enhancement promotes heat efficiency during operation of the heat exchanger.

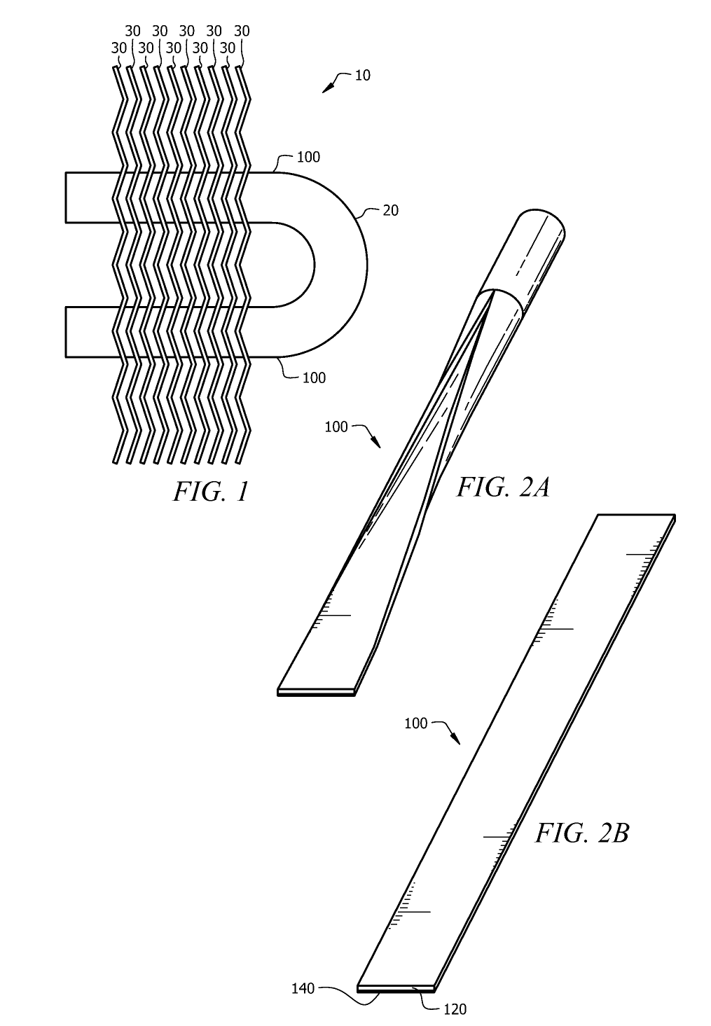

FIG. 1 illustrates a portion of a tube and fin heat exchanger system 10. It should be understood that system 10 shown in FIG. 1 is for illustrative purposes only and that any other suitable system or subsystem could be used in conjunction with, or in lieu of, system 10 according to one embodiment of the present disclosure.

System 10 may generally comprise any number of hairpin tubes 100, 200. In an embodiment, hairpin tubes 100, 200 may be generally positioned in a parallel orientation. Each hairpin tube 100, 200 may be coupled with an adjacent hairpin tube 100, 200 through any suitable coupling mechanism, such as, for example, return bends 20. In an embodiment, system 10 may further include a plurality of fins 30, each of which may generally be disposed perpendicularly to the hairpin tubes 100, 200 according to an embodiment of the present disclosure.

It should be also understood that hairpin tubes 100, 200 and fins 30 shown in FIG. 1 is for illustrative purposes only and that any other suitable system or subsystem could be used in conjunction with, or in lieu of, hairpin tubes 100, 200 and fins 30 according to one embodiment of the present disclosure.

FIG. 2A depicts a partially exploded view of a hairpin tube 100 according to one embodiment of the present disclosure. FIG. 2B depicts a perspective view of hairpin tube 100 in a pre-formed state according to one embodiment of the present disclosure. According to an embodiment, each hairpin tube 100 may be may be formed by any suitable method that produces a hollow hairpin tube 100, such as, for example, via extrusion, rolling and securing a sheet of metal into a cylindrical shape, other suitable method, or any combination thereof.

In an embodiment, hairpin tube 100 may be comprised of a metal alloy 120. The surface of metal alloy 120 may be cladded with a layer of braze alloy 140 according to one embodiment.

In one embodiment, braze alloy 140 may be sprayed onto the hairpin tube 100 prior to, simultaneously with or after hairpin tube 100 is formed via extrusion. Alternatively, braze alloy 140 may be mechanically coupled to hairpin tube 100 prior to, simultaneously with or after hairpin tube 100 is formed via extrusion.

In another embodiment, braze alloy 140 may be sprayed onto hairpin tube 100 prior to, simultaneously with or after hairpin tube 100 is formed by rolling a sheet of metal alloy 120 into a cylindrical shape and securing the rolled metal alloy 120 in the cylindrical shape by welding along the seam formed between the two ends of the sheet when in the cylindrical shape. Alternatively, braze alloy 140 may be mechanically coupled to hairpin tube 100 prior to, simultaneously with or after hairpin tube 100 is formed by securing the rolled metal alloy 120 in the cylindrical shape.

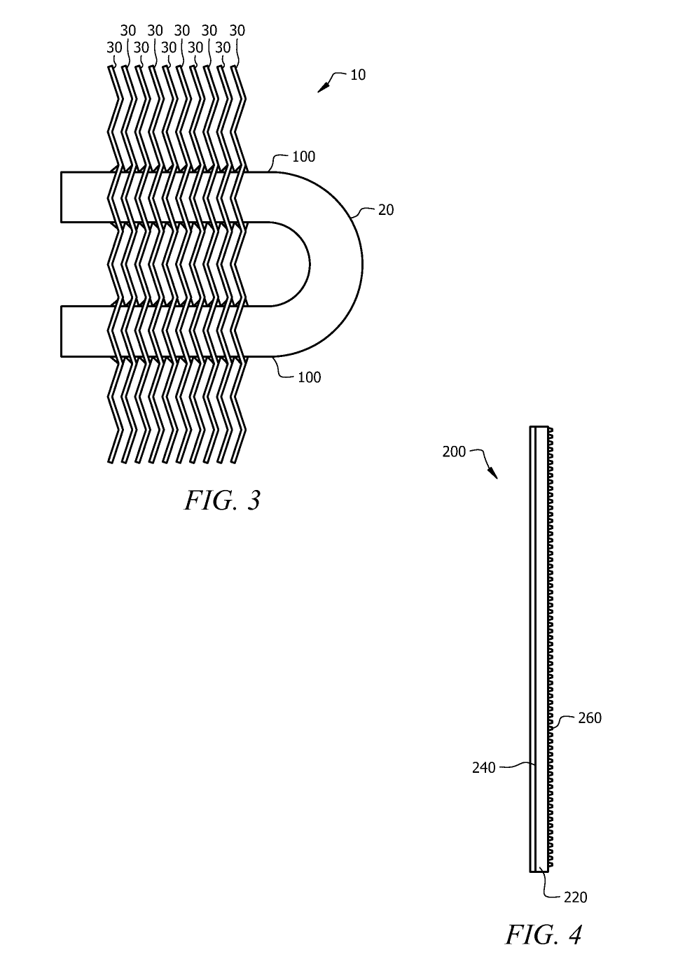

In an embodiment, metal alloy 120 may be a heat treatable alloy thereby allowing hairpin tubes 100 and fins to be treated in an annealing furnace to create a metallurgic bond between hairpin tubes 100 and fins 30, as shown in FIG. 3. Allowing for furnace heat treatment, rather than causing expansion of the hairpin tubes 100 radially outward to engage and exert force against the fins 30, may relieve or eliminate stress on the hairpin tubes 100, and thereby reduce the risk of corrosion and reduce the cost and maintenance on tooling.

In an embodiment, a decreased number of fins 30 may be required due to the improved heat transfer efficiency caused by the heat treated metallurgic bond.

In an embodiment, metal alloy 120 may be comprised of AA2XXX (i.e. 2000 series) aluminum alloy material, AA6XXX (i.e. 6000 series) aluminum alloy material, AA7XXX (i.e. 7000 series) aluminum alloy material other suitable material, or any combination thereof.

In an embodiment, braze alloy 140 may be formed of a metal or material having a lower melting temperature than metal alloy 120. In operation, this facilitates the creation of the metallurgic bond between the hairpin tubes 100 and fins 30, without adversely effecting metal alloy 120.

The material(s) included in the metal alloy 120 may be selected to not substantially deform and/or degrade in the operation temperatures. For example, the metallurgic bond may be created during furnace heat treatment at a temperature between 900° F. to 1150° F. The material(s) included in the metal alloy 120 may not substantially degrade and/or deform at 900° F. to 1150° F. when the hairpin tubes 100 and fins are heat treated.

In an embodiment, braze alloy 140 may be comprised of AA4XXX aluminum alloy material, other aluminum material with a different ratio of zinc to aluminum other suitable material, or any combination thereof.

Employing brazed alloy 140 cladded hairpin tubes 100 to allow furnace heat treatment rather than expansion allows for substantially higher heat transfer efficiency.

In an embodiment, employing brazed alloy 140 cladded hairpin tubes 100 to allow furnace heat treatment further provides for any length (L) of hairpin tube 100 to be utilized as expansion of the hairpin tube 100, through the use of length-restricting expanders, is no longer required. In an embodiment, hairpin tubes 100 may have a length (L) of more than 110 inches.

In an embodiment, employing brazed alloy 140 cladded hairpin tubes 100 to allow furnace heat treatment also provides for the utilization of hairpin tubes 100 having a diameter (D). Diameter (D) may have any value, as the hairpin tubes 100 no longer have to be sized so as to accommodate expanders. In an embodiment, hairpin tubes 100 may have a diameter (D) of less than 0.325 inches. Using hairpin tubes 100 with smaller diameters allows for less refrigerant to be necessary during the operation of system 10.

FIGS. 4-7 generally illustrate a hairpin tube 200 according to another embodiment of the present disclosure. In one embodiment, hairpin tubes 200 could generally be similar to hairpin tubes 100 shown in and described in conjunction with FIG. 2 above (with like parts having similar numbers).

In an embodiment, hairpin tube 200 may be comprised of a metal alloy 220. In one embodiment, each hairpin tube 200 may be formed by rolling a sheet of metal alloy 220 into a cylindrical shape and securing the rolled metal alloy 220 in the cylindrical shape by welding along the seam formed between the two ends of the sheet when in the cylindrical shape.

According to one embodiment, one surface of a sheet of metal alloy 220 may be cladded with a layer of braze alloy 240, as shown in FIGS. 4. Metal alloy 220 may further comprise enhancements 260 disposed on the opposite surface of the metal alloy 220, as shown in FIG. 4. Enhancements 260 may be employed to further increase heat transfer efficiency.

In an embodiment, braze alloy 240 may be sprayed onto the sheet of metal alloy 220. Alternatively, braze alloy 140 may be mechanically coupled to the sheet of metal alloy 220.

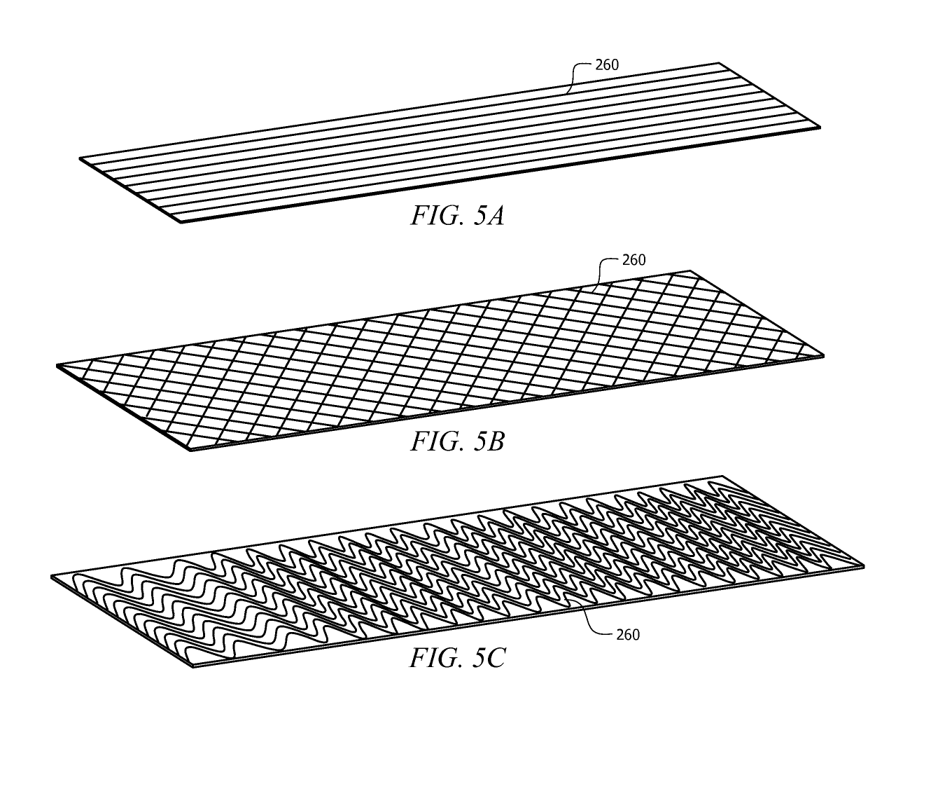

In an embodiment, enhancements 260 may be formed by surface treatment of the metal alloy 220. In various embodiments, enhancements 260 may comprise various patterns, such as, for example, linear trenches as shown in FIG. 5a, crosshatched trenches as shown in FIG. 5b, wavy trenches as shown in FIG. 5c, other suitable patterns, or any combination thereof.

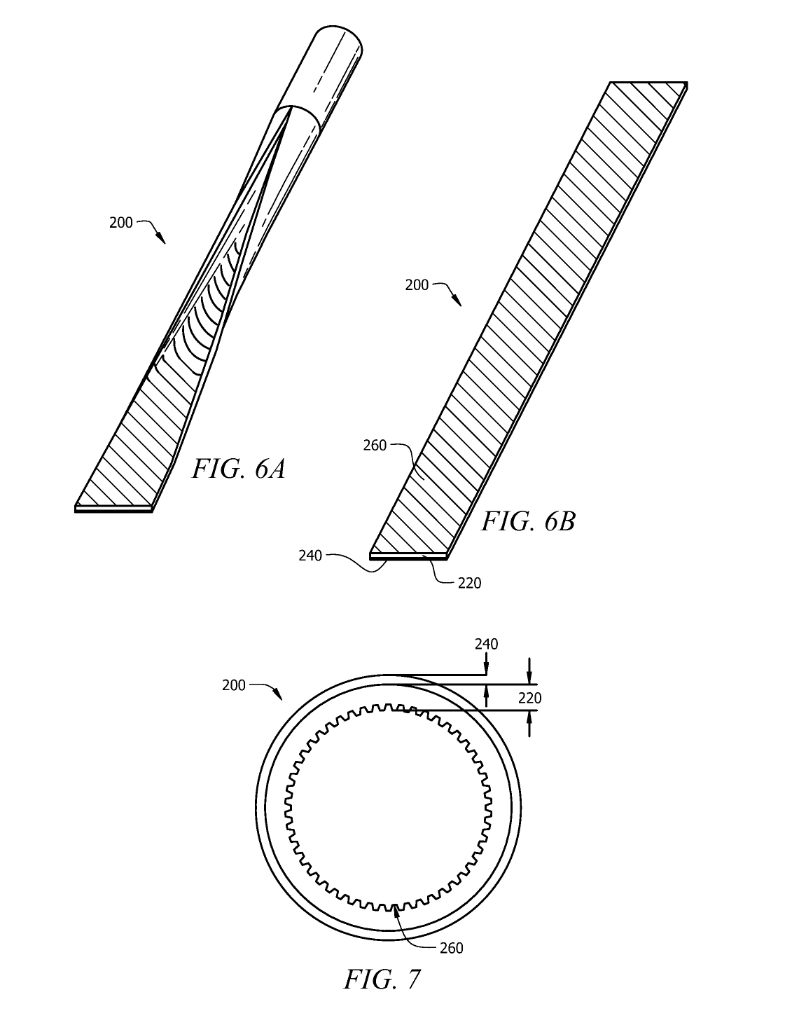

FIG. 6A depicts a partially exploded view of hairpin tube 200 after the sheet of metal alloy 220, which is shown in FIG. 6B, is rolled and welded according to one embodiment of the present disclosure, while FIG. 7 illustrates a cross section view of the formed hairpin tube 200 to show the orientation of the layers of the hairpin tube 200.

In an embodiment, metal alloy 220 may be a heat treatable alloy thereby allowing hairpin tubes 200 and fins to be treated in an annealing furnace to create a metallurgic bond between hairpin tubes 200 and fins 30. Allowing for furnace heat treatment, rather than causing expansion of the hairpin tubes 200 radially outward to engage and exert against the fins 30, may relieve stress on the hairpin tubes 200, and thereby reduce the risk of corrosion and reduce the cost and maintenance on tooling.

In an embodiment, a decreased number of fins 30 may be required due to the improved heat transfer efficiency caused by the heat treated metallurgic bond.

In an embodiment, metal alloy 220 may be comprised of AA2XXX aluminum alloy material, AA6XXX aluminum alloy material, AA7XXX aluminum alloy material, other suitable material, or any combination thereof.

In an embodiment, braze alloy 240 may be formed of a metal or material having a lower melting temperature than metal alloy 220. In operation, this facilitates the creation of the metallurgic bond between the hairpin tubes 200 and fins 30, without adversely effecting metal alloy 220.

The material(s) included in the metal alloy 220 may be selected to not substantially deform and/or degrade in the operation temperatures. For example, the metallurgic bond may be created during furnace heat treatment at a temperature between 900° F. to 1150° F. The material(s) included in the metal alloy 220 may not substantially degrade and/or deform at 900° F. to 1150° F. when the hairpin tubes 200 and fins are heat treated.

In an embodiment, braze alloy 240 may be comprised of AA4XXX aluminum alloy material, other aluminum material, with a different ratio of zinc to aluminum, other suitable material, or any combination thereof.

Various described processes may be implemented by various described systems. In addition, various operations may be added, deleted, and/or modified. In some implementations, one or more of the described process may be performed in combination with other processes and/or operations of processes.

It is to be understood the implementations are not limited to particular systems or processes described which may, of course, vary. It is also to be understood that the terminology used herein is for the purpose of describing particular implementations only, and is not intended to be limiting. As used in this specification, the singular forms “a”, “an” and “the” include plural referents unless the content clearly indicates otherwise. Thus, for example, reference to “a hairpin tube” includes a combination of two or more hairpin tubes; and, reference to “a metal alloy” includes different types and/or combinations of metal alloys. Similarly, by way of further example, reference to “a braze alloy” includes different types and/or combinations of braze alloys.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A heat exchanger for use in a heating, ventilation and air conditioning (HVAC) system, the heat exchanger comprising:
at least one hairpin tube; and
at least one fin;
wherein the hairpin tube is made of a metal; and
wherein the hairpin tube is cladded in a braze alloy.

2. The heat exchanger of claim 1, wherein the braze alloy is sprayed onto the hairpin tube.

3. The heat exchanger of claim 1, wherein the hairpin tube is formed by rolling and securing a sheet of material into a cylindrical shape.

4. The heat exchanger of claim 3, wherein the braze alloy is mechanically coupled to a sheet of the metal to form the sheet of material.

5. The heat exchanger of claim 1, wherein the hairpin tube is formed by extrusion.

6. The heat exchanger of claim 5, wherein the braze alloy is mechanically coupled to the hairpin tube after extrusion.

7. The heat exchanger of claim 1, wherein the metal is a heat treatable alloy.

8. The heat exchanger of claim 1, wherein the braze alloy has a lower melting temperature than the metal.

9. The heat exchanger of claim 1, wherein the braze alloy is formed of one of the following: zinc, aluminum, and silicon.

10. The heat exchanger of claim 1, wherein the hairpin tube has a diameter less than 0.325 inches.

11. A heat exchanger for use in a heating, ventilation and air conditioning (HVAC) system, the heat exchanger comprising:
at least one hairpin tube formed by rolling and securing a sheet of a metal into a cylindrical shape; and
at least one fin;
wherein the hairpin tube is cladded in a braze alloy, and
wherein the sheet of the metal comprises enhancements formed by surface treatment.

12. The heat exchanger of claim 11, wherein the braze alloy is sprayed onto the hairpin tube.

13. The heat exchanger of claim 11, wherein the braze alloy is mechanically coupled to the hairpin tube.

14. The heat exchanger of claim 11, wherein the enhancements comprise of liner trenches.

15. The heat exchanger of claim 11, wherein the enhancements comprise of crosshatched trenches.

16. The heat exchanger of claim 11, wherein the enhancements comprise of wavy trenches.

17. The heat exchanger of claim 11, wherein the metal is a heat treatable alloy.

18. The heat exchanger of claim 11, wherein the braze alloy has a lower melting temperature than the metal.

19. A method for forming a heat exchanger for use in a heating, ventilation and air conditioning (HVAC) system, the method comprising:
cladding hairpin tubes with a braze alloy;
positioning fins to engage the braze alloy; and
forming a metallurgic bond between the fins and hairpin tubes by heat treating.

20. The method of claim 19, further comprising:
mechanically surface treating a interior surface of the hairpin tubes to form enhancements.
